(19) United States
(12) Patent Application Publication
(10) Pub. No.: US 2024/0419486 A1
(43) Pub. Date: Dec. 19, 2024

(54) PREDICTING TASK EXECUTION EFFORTS USING ARTIFICIAL INTELLIGENCE TECHNIQUES

(71) Applicant: Dell Products L.P., Round Rock, TX (US)

(72) Inventors: Bijan Kumar Mohanty, Austin, TX (US); Manoj Nambirajan, Hyderabad Telangana (IN); Hung T. Dinh, Austin, TX (US); Mohit Kumar Agarwal, Cyberjaya (MY)

(21) Appl. No.: 18/210,220

(22) Filed: Jun. 15, 2023

(51) Int. Cl. G06F 9/48; G06F 9/30

(52) U.S. Cl. CPC G06F 9/4881; G06F 9/3005

(57) ABSTRACT

Methods, apparatus, and processor-readable storage media for predicting task execution efforts using artificial intelligence techniques are provided herein. An example computer-implemented method includes determining intent information associated with at least a portion of a task by processing data related to the task using at least a first set of artificial intelligence techniques; determining task execution workflow data based at least in part on the intent information associated with at least a portion of the task; predicting one or more efforts associated with executing the task by processing at least a portion of the task execution workflow data using at least a second set of artificial intelligence techniques; and performing one or more automated actions based at least in part on at least one of the one or more predicted efforts associated with executing the task.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

In task development scenarios, it can be challenging to predict or estimate the effort(s) needed to execute tasks due to a variety of factors that are specific to various task parameters (e.g., product(s) involved, relevant enterprise dynamics, technology selected, etc.). Additionally, evolving technology and/or hosting platforms can introduce complexities in predicting or estimating the effort(s) needed to execute tasks. However, conventional task development approaches include resource-intensive and error-prone effort estimation techniques.

### SUMMARY

Illustrative embodiments of the disclosure provide techniques for predicting task execution efforts using artificial intelligence techniques.

An exemplary computer-implemented method includes determining intent information associated with at least a portion of a task by processing data related to the task using at least a first set of artificial intelligence techniques, and determining task execution workflow data based at least in part on the intent information associated with at least a portion of the task. The method also includes predicting one or more efforts associated with executing the task by processing at least a portion of the task execution workflow data using at least a second set of artificial intelligence techniques. Additionally, the method includes performing one or more automated actions based at least in part on at least one of the one or more predicted efforts associated with executing the task.

Illustrative embodiments can provide significant advantages relative to conventional task development approaches. For example, problems associated with resource-intensive and error-prone effort estimation techniques are overcome in one or more embodiments through automatically predicting one or more task execution efforts using artificial intelligence techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for predicting task execution efforts using artificial intelligence techniques in an illustrative embodiment.

FIG. 2 shows example system architecture in an illustrative embodiment.

FIG. 3 shows an example bi-directional long short-term memory (bi-LSTM) network in an illustrative embodiment.

FIG. 4 shows an architecture diagram of a task story intent prediction engine in an illustrative embodiment.

FIG. 5 shows example pseudocode for implementing at least a portion of an intent prediction engine in an illustrative embodiment.

FIG. 6 shows an architecture diagram of a task story effort prediction engine in an illustrative embodiment.

FIG. 7 shows an example architecture diagram of a multi-output neural network for story execution effort predictions in an illustrative embodiment.

FIG. 8 shows example pseudocode for data preprocessing in an illustrative embodiment.

FIG. 9 shows example pseudocode for encoding categorical values into numerical values in an illustrative embodiment.

FIG. 10 shows example pseudocode for splitting a dataset into training and testing sets in an illustrative embodiment.

FIG. 11 shows example pseudocode for neural network model creation in an illustrative embodiment.

FIG. 12 shows example pseudocode for model compiling and model training in an illustrative embodiment.

FIG. 13 shows example pseudocode for generating a prediction using the trained model in an illustrative embodiment.

FIG. 14 is a flow diagram of a process for predicting task execution efforts using artificial intelligence techniques in an illustrative embodiment.

FIGS. 15 and 16 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

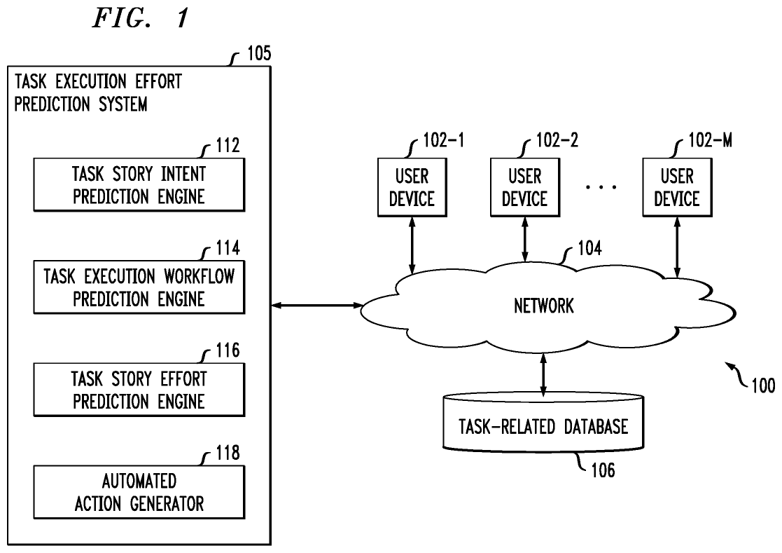

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is task execution effort prediction system 105.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, task execution effort prediction system 105 can have an associated task-related database 106 configured to store data pertaining to task-related data, which comprise, for example, task execution information, task-related temporal requirements, task-related resource requirements, task-related story information, task-related intent information, etc.

The task-related database 106 in the present embodiment is implemented using one or more storage systems associated with task execution effort prediction system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with task execution effort prediction system 105 are one or more input-output devices, which illustratively comprise keyboards, displays or other types of input-output devices in any combination. Such input-output devices can be used, for example, to support one or more user interfaces to task execution effort prediction system 105, as well as to support communication between task execution effort prediction system 105 and other related systems and devices not explicitly shown.

Additionally, task execution effort prediction system 105 in the FIG. 1 embodiment is assumed to be implemented using at least one processing device. Each such processing device generally comprises at least one processor and an associated memory, and implements one or more functional modules for controlling certain features of task execution effort prediction system 105.

More particularly, task execution effort prediction system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows task execution effort prediction system 105 to communicate over the network 104 with the user devices 102, and illustratively comprises one or more conventional transceivers.

The task execution effort prediction system 105 further comprises task story intent prediction engine 112, task execution workflow prediction engine 114, task story effort prediction engine 116, and automated action generator 118.

It is to be appreciated that this particular arrangement of elements 112, 114, 116 and 118 illustrated in the task execution effort prediction system 105 of the FIG. 1 embodiment is presented by way of example only, and alternative arrangements can be used in other embodiments. For example, the functionality associated with elements 112, 114, 116 and 118 in other embodiments can be combined into a single module, or separated across a larger number of modules. As another example, multiple distinct processors can be used to implement different ones of elements 112, 114, 116 and 118 or portions thereof.

At least portions of elements 112, 114, 116 and 118 may be implemented at least in part in the form of software that is stored in memory and executed by a processor.

It is to be understood that the particular set of elements shown in FIG. 1 for predicting task execution efforts using artificial intelligence techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, task execution effort prediction system 105 and task-related database 106 can be on and/or part of the same processing platform.

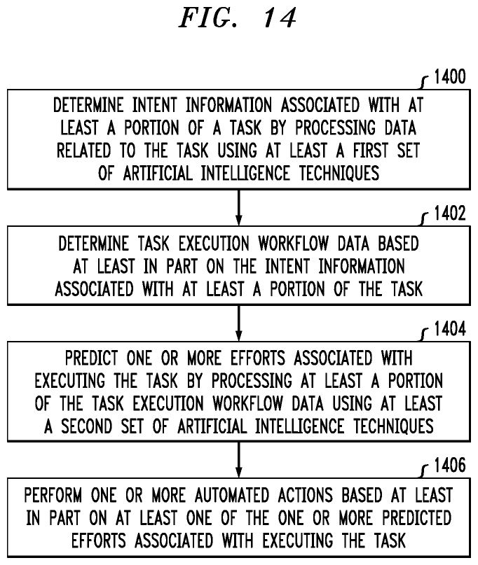

An exemplary process utilizing elements 112, 114, 116 and 118 of an example task execution effort prediction system 105 in computer network 100 will be described in more detail with reference to the flow diagram of FIG. 14.

Accordingly, at least one embodiment includes predicting task execution efforts (e.g., an estimation of the number of resources required for executing the given task, an estimation of the amount of time required for executing the given task, etc.) using artificial intelligence techniques. As detailed herein, such an embodiment includes leveraging insights derived from past task execution experience to predict future execution efforts (e.g., sizing-related efforts) for one or more tasks. Such leveraging can involve, for example, using one or more natural language processing (NLP) techniques and/or one or more deep neural network-based regression techniques.

As noted above and further detailed herein, one or more embodiments include predicting sizing-related efforts for task execution. With respect to sizing-related efforts, a product or application can include many individual tasks referred to herein as “stories,” which can represent enterprise or business requirements. Accordingly, an objective of one or more embodiments includes using artificial intelligence techniques to predict how many resources and how much time is needed to complete each individual story for a given product or application. By way of further example, by multiplying the number of resources and the predicted amount of time (e.g., a predicted number of hours), at least one embodiment can include determining the resource time which can then be converted into monetary values for each story. Additionally, by summing this execution value for all tasks of a given product or application, such an embodiment can include computing the sizing cost the product-related or application-related execution.

Additionally, predicting task execution efforts in accordance with one or more embodiments can include performing and/or initiating one or more automated actions such as, for example, modifying task-related decision-making with respect to technology, scope, deployment platform(s), enterprise objectives, etc., thus improving the timeline and/or effectiveness of the task(s) in question.

In at least one embodiment, one or more NLP techniques are used to process data related to a proposed story to determine and/or identify intent information pertaining to the proposed story. Such an embodiment can include processing a story written in natural language, and converting such processed natural language data into one or more vectors which can then passed to and/or processed by a classifier to predict the story intent. As used and further detailed herein, a story represents at least one free form natural language text sentence which is used to predict at least one intent that corresponds to concrete work involved in the story. For example, an illustrative story that includes “Ability for partners to compare key features in products” can be translated to an intent of “sales.product.comparison,” which indicates a product comparison functionality in the sales module. Such intents are often reusable, as, for example, other stories have likely been implemented using this intent in the past. Based on how many resources were used in connection with execution and the time duration involved therewith, artificial intelligence techniques utilized in connection with one or more embodiments can predict the effort (e.g., the amount of resources and the time required for execution) for a new and/or additional instance of the same story intent.

Additionally, such an embodiment can include obtaining and/or utilizing historical execution data (e.g., enterprise domain, product type, technological details (programming language, database(s), application programming interfaces (APIs), etc.), hosting platform(s) (public cloud, private cloud, hybrid, etc.), facing (external, internal, or both), etc.) associated with each type of determined and/or identified story intent from other tasks. Such historical execution data can then be used, for example, as one or more training indicators of future effort estimations of new tasks.

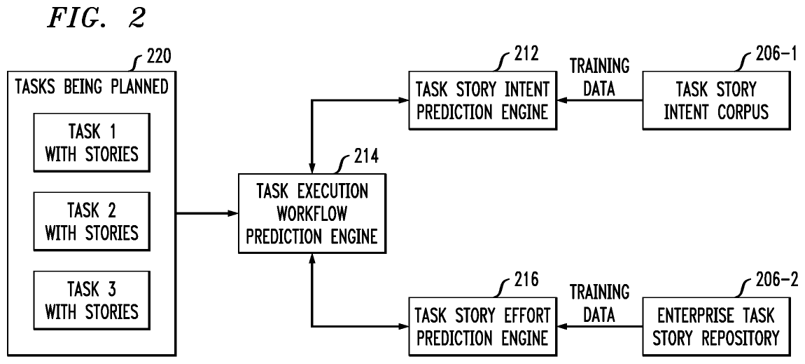

FIG. 2 shows example system architecture in an illustrative embodiment. By way of illustration, FIG. 2 depicts task story intent prediction engine 212, task execution workflow prediction engine 214, task story intent corpus 206-1, enterprise task story repository 206-2, and task story effort prediction engine 216. More specifically, task execution workflow prediction engine 214 receives input from tasks being planned 220 (wherein such input can include information pertaining to various tasks with stories) and returns the total estimated effort of one or more of the tasks being planned 220.

The stories that are part of the tasks being planned 220 are passed as an input to the task execution workflow prediction engine 214, which processes at least a portion of such information in conjunction with task story intent prediction engine 212. More specifically, in one or more embodiments, story information from the tasks being planned 220 is processed by task story intent prediction engine 212 to predict and/or identify story intent information for at least a portion of the tasks being planned 220. Additionally, task execution workflow prediction engine 214 leverages the story intent information predicted by task story intent prediction engine 212 to determine and/or predict at least one workflow for executing at least a portion of the tasks being planned (e.g., at least one execution sequence with related temporal information). As depicted in FIG. 2, task execution workflow prediction engine 214 invokes task story intent prediction engine 212 by passing the story description from the tasks being planned 220, and then receives, from task story intent prediction engine 212, the intent(s) of the task. Then, task execution workflow prediction engine 214 passes at least a portion of the intent data (e.g., a portion of the intent data in a particular sequence or implementation order) to task story effort prediction engine 216 to return output values (e.g., the number of resources needed and the time needed to implement the intent).

Accordingly, task story effort prediction engine 216, based at least in part on the at least one workflow determined and/or predicted by task execution workflow prediction engine 214, predicts the efforts required to execute each story of the tasks being planned 220. In one or more embodiments, task story effort prediction engine 216 uses a multi-target neural network that has two parallel branches to predict the number of resources needed for execution and the amount of time (e.g., the number of hours) needed for execution using the same input (intent, domain, language, database, deployment stack, etc.). Also, in at least one embodiment, task story effort prediction engine 216 sums at least a portion of such predicted efforts to compute the total effort of the execution of at least one of the tasks being planned 220.

Enterprise task story repository 206-2 and task story intent corpus 206-1 represent repositories of historical task and/or story execution data and task stories in at least one enterprise. Also, in one or more embodiments, the enterprise task story repository 206-2 and task story intent corpus 206-1 can contain the language corpus of enterprise stories (e.g., for NLP purposes to identify story intent) as well as historical efforts for each story (e.g., for regression purposes). Such data can be used for training the task story intent prediction engine 212 and task story effort prediction engine 216, respectively. Further, the enterprise task story repository 206-2 and task story intent corpus 206-1 can store story feature descriptions and their related intents and use at least a portion of such data for intent prediction purposes.

With respect to the task story intent prediction engine 212, as feature stories are typically written at the beginning stage of task planning, it can be important to identify the intent of each story (wherein the intent of each story can also be referred to as the objective(s) of that portion of the overall task) in an automatic manner before the corresponding efforts can be predicted. In one or more embodiments, because feature stories are often written using natural language, such an embodiment includes initially using one or more NLP techniques to predict the intent of each story. Accordingly, the task story intent prediction engine 212 can also use natural language understanding (NLU) techniques and one or more neural networks for analyzing the feature description(s) and classifying the corresponding intent(s). Considering, in at least one embodiment, that a story description can be similar to a time series model wherein the words come one after another in time and/or space, such an embodiment can include leveraging a form of recurrent neural network (RNN) referred to as a bi-directional RNN, which uses two separate processing sequences, one from left to right and another from right to left. As RNNs can have the tendency to have exploding or vanishing gradient issues for longer and complex dialogs and/or messages, one or more embodiments include leveraging a bi-directional RNN with at least one long short-term memory (LSTM) network in connection with the NLU techniques.

By way of example, considering that a story description in natural language is similar to a time series model wherein the words come one after another in time and space, at least one embodiment includes leveraging a form of RNN. To better understand the context and analyze the message (for example, why a certain word is used will require the context of another word used before or after that word), such an embodiment includes using a bi-directional RNN which uses two separate processing sequences, one from left to right and another from right to left. As RNNs can have tendencies related to exploding or vanishing gradient issues for longer and complex dialogs and/or messages, at least one embodiment includes further leveraging a specific type of bi-directional RNN referred to as a bi-directional RNN with LSTM for NLU techniques.

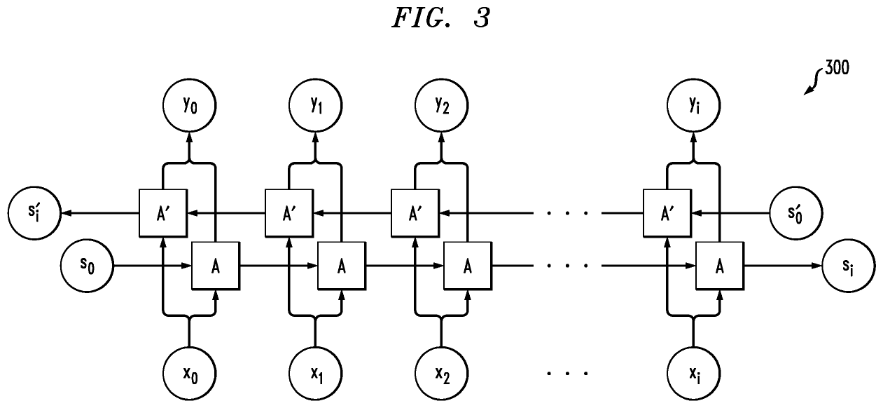

FIG. 3 shows an example bi-LSTM network 300 in an illustrative embodiment. More specifically, FIG. 3 depicts a bi-directional RNN with LSTM. RNNs are a type of neural network wherein the output from previous step feeds into the input of the current step. In such a neural network, also referred to as a feed forward network, input and output are independent. In connection with a language processing model (such as, for example, in connection with one or more embodiments), it is important to remember the previous word(s) before predicting the next word of a sentence. Accordingly, an RNN, which has a hidden state which remembers one or more words in a sentence, can be utilized and/or implemented. If a given sentence is too long, some of that previous information may not be available in the limited hidden state, which requires the need for bi-directional processing of the sentence (from the past and the future in two sequences parallelly) as carried out in a bi-directional RNN such as depicted in FIG. 3. In such an embodiment, LSTM introduces advanced memory units and gates to an RNN which can be used to improve the accuracy and/or performance of the model. Accordingly, as further detailed herein, in a bi-directional RNN, there is a forward flow and a backward flow (a past to future flow and a future to past flow). As depicted in example bi-LSTM network 300, “x” values represent the input variables and “y” values represent the output. In an RNN, the output of one layer is fed into the input of the next, and “A” and “A” represent the states of the forward flow (from state s₀ to state sᵢ) and the backward flow (from state s′₀ to state s′ᵢ), respectively.

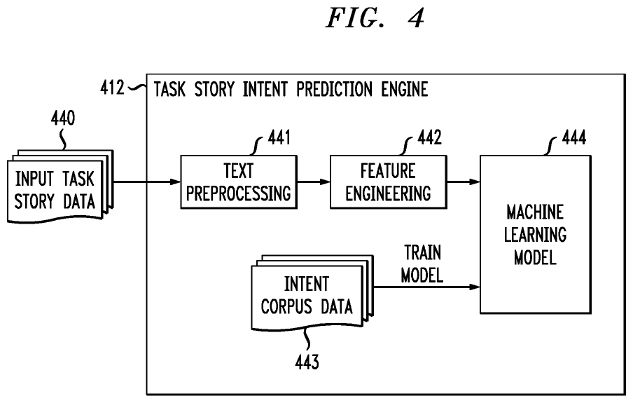

FIG. 4 shows an architecture diagram of a task story intent prediction engine 412 in an illustrative embodiment. By way of illustration, FIG. 4 depicts an example intent analysis framework which starts with a set of intent corpus data 443 used to train a machine learning model (e.g., a bi-LSTM network). Such intent corpus data 443 can contain words and phrases of multiple sentences, as well as the intent associated with each of these sentences.

As also depicted in FIG. 4, task story intent prediction engine 412 obtains input task story data 440, which are preprocessed in step 441, for example, to clean any unwanted characters and/or stop words, to perform stemming and/or lemmatization, to change text to a given case (e.g., lower case), to remove punctuation, to remove bad and/or erroneous characters, etc. Once preprocessing is completed, at least one feature engineering step is carried out in step 442. For example, such feature engineering can include tokenizing the input list of words (in at least one given sentence). Such tokenization can include, for example, using a Keras library, a NLTK library, etc. In at least one embodiment, a Keras tokenizer class is used to index the tokens.

By way merely of example, input task story data 440 and related intent might include the following. A product story description can include “Ability of receiving employee details in a customer relationship management system from a human resources system,” and the corresponding intent can include “integration.lightning.workday.” Additionally, a product story description can include “Ability to show the duration of a dispatch in workorder,” and the corresponding intent can include “support.case.workorder.”

After tokenization, one or more embodiments include padding and/or modifying the tokens to make them of equal length so that they can be used and/or processed by machine learning model 444. Additionally or alternatively, at least one embodiment includes performing one or more output encoding operations (e.g., one-hot encoding) on the preprocessed text, in conjunction with tokenization and padding. Accordingly, subsequent to step 442, at least one list of intent information is indexed and ready to be processed by machine learning model 444.

As noted above, intent corpus data 443 are used to train the machine learning model 444, which can then be implemented to process input task story data 440 (subsequent to preprocessing in step 441 and feature engineering in step 442) to predict one or more intents associated with such data. As also noted above, in one or more embodiments, machine learning model 444 can include a bi-directional RNN model with LSTM created using a Keras library. Parameters of such a model that can be tuned and/or modified during or after creation can include, for example, an Adam optimizer, a Softmax activation function, a given batch size, a given number of epochs, etc. In connection with such parameter tuning, at least one embodiment includes calculating the accuracy of the model and performing further hyperparameter tuning based at least in part thereon.

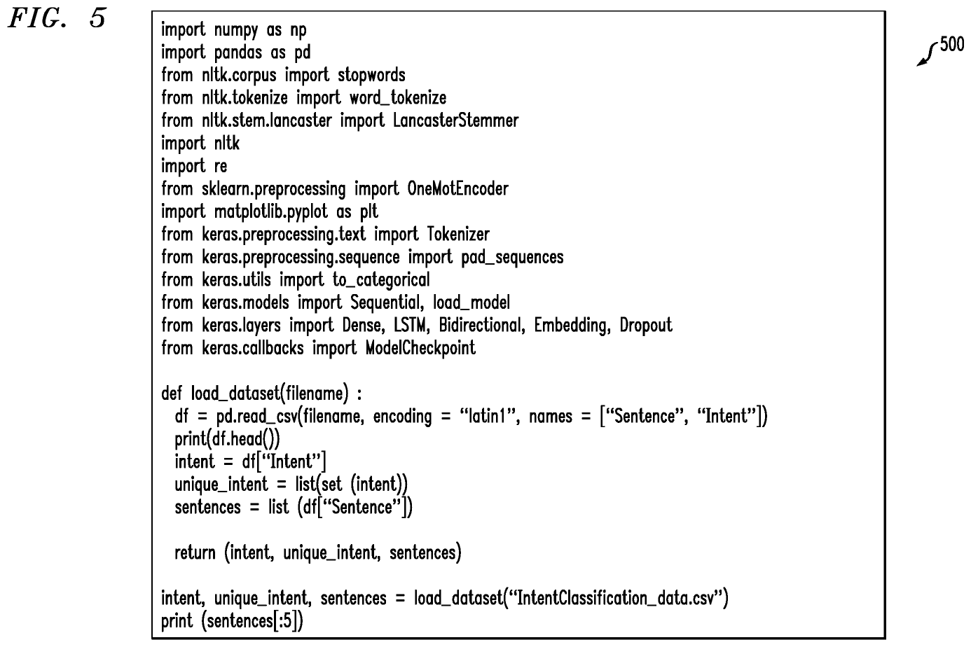

FIG. 5 shows example pseudocode for implementing at least a portion of an intent prediction engine in an illustrative embodiment. In this embodiment, example pseudocode 500 is executed by or under the control of at least one processing system and/or device. For example, the example pseudocode 500 may be viewed as comprising a portion of a software implementation of at least part of task execution effort prediction system 105 of the FIG. 1 embodiment.

The example pseudocode 500 illustrates implementing Python language as well as Numpy, Pandas, Keras and natural language toolkit (NLTK) libraries. Also, example pseudocode 500 illustrates processing a dataset and predicting the intent of a task story derived therefrom, and passing the intent to an additional and/or separate component to predict the total efforts (e.g., the number of resources needed, the number of hours needed, etc.) to execute the story of the task.

It is to be appreciated that this particular example pseudocode shows just one example implementation of at least a portion of an intent prediction engine, and alternative implementations can be used in other embodiments.

As detailed herein (such as, for example, in connection with task story effort prediction engine 216 in FIG. 2), one or more embodiments include implementing a task story effort prediction engine. In such an embodiment, such a prediction engine can predict task and/or story execution efforts with respect to the number of resources (e.g., Java developers, solution architects, etc.) and the total amount of time needed to execute the task, and such predictions can be made using the same set of input feature data (e.g., date/time, task story intent information, task type, domain, technologies used (language, database, stack, etc.), consumption pattern (internal, external, or both), deployment and/or hosting pattern (public cloud, private cloud, or hybrid cloud), etc.).

FIG. 6 shows an architecture diagram of a task story effort prediction engine 616 in an illustrative embodiment. By way of illustration, FIG. 6 depicts historical task story execution data 661, which is used to train machine learning model 662, which can include a multi-target regression model and/or a multi-output regressor). As also depicted in FIG. 6, task story intent information 660 can then be processed by machine learning model 662 to generate an output of a predicted number of resources needed for executing the task and/or story, and an output of a predicted total execution effort time (e.g., in minutes or hours) for the task and/or story.

Additionally, in at least one embodiment, once the task story intent information 660 is obtained and/or collected, data engineering and exploratory data analysis can be carried out to identify one or more important features and/or columns that can influence the target variables (both the number of resources and the total number of hours to execute the task and/or story). Such an analysis can also facilitate identifying unnecessary columns and one or more features that are highly correlated, which can lead to removing one or more corresponding columns and/or features to reduce data dimensionality and model complexity, as well as improving the performance and accuracy of the machine learning model 662.

In one or more embodiments, machine learning model 662 includes a deep neural network that has two parallel branches, both acting as regressors (e.g., one for predicting the number of resources needed to execute the task and/or story and the other for predicting the total amount of time needed to execute the task and/or story). By taking the same set of input variables as a single input layer and building a dense, multi-layer neural network, such a machine learning model 662 can act as a sophisticated network of two regressors for multi-output predictions.

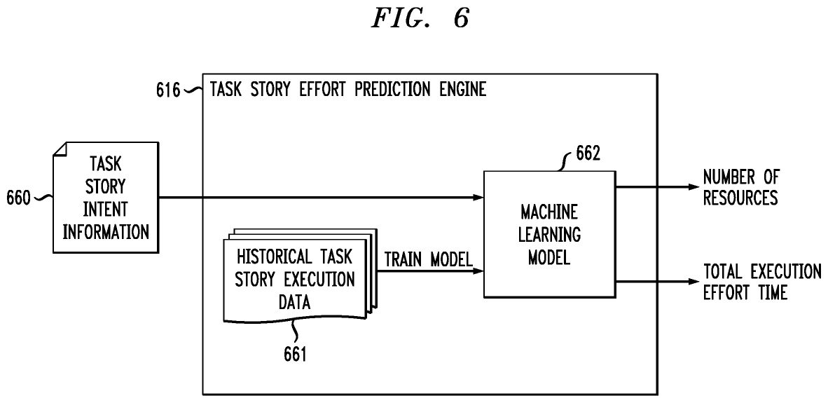

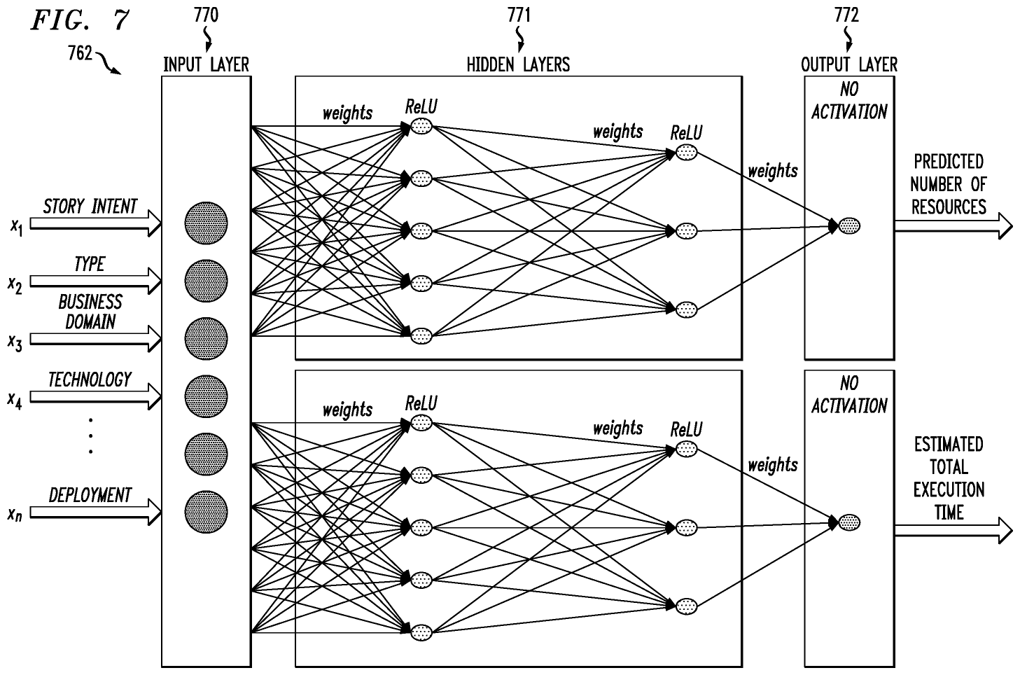

FIG. 7 shows an example architecture diagram of a multi-output neural network 762 for story execution effort predictions in an illustrative embodiment. By way of illustration, FIG. 7 depicts the multi-output neural network 762 which includes an input layer 770, hidden layers 771 (e.g., two hidden layers) and an output layer 772. As a multi-output neural network, two separate branches of a network are created and implemented, in the hidden layers 771 and the output layer 772, that connect to the same input layer 770.

As depicted in FIG. 7, input layer 770 includes a number of neurons that matches the number of input/independent variables, such as, for example, story intent (x₁), type (x₂), business domain (x₃), technology (x₄), . . . , deployment (xₙ). Hidden layers 771, in the example embodiment depicted in FIG. 7, include two layers each implementing a rectified linear unit (ReLU) activation function, and the number of neurons on each layer depends upon the number of neurons in the input layer 770. Also, each branch of the output layer 772 can contain a different number of neurons depending, for example, upon the type of output(s) needed. In the example embodiment depicted in FIG. 7, as both output layer branches represent regressors, each branch will use just one neuron. Specifically, one of the two separate regressor branches of the output layer 772 includes no activation function and estimates and/or predicts the number of resources needed to execute the task and/or story, and the other regressor branch of the output layer 772 includes no activation function and estimates and/or predicts the total amount of time needed to execute the task and/or story.

By way of further example and illustration, implementation of a task story effort prediction engine can be achieved, as shown in FIG. 8 through FIG. 13, using Keras with TensorFlow backend, Python language, as well as Pandas, Numpy and ScikitLearn libraries.

FIG. 8 shows example pseudocode for data preprocessing in an illustrative embodiment. In this embodiment, example pseudocode 800 is executed by or under the control of at least one processing system and/or device. For example, the example pseudocode 800 may be viewed as comprising a portion of a software implementation of at least part of task execution effort prediction system 105 of the FIG. 1 embodiment.

The example pseudocode 800 illustrates reading the dataset of the historical task story execution data file and generating a Pandas dataframe, which contains columns including independent variables and dependent/target variable columns (a resource needed column and a time needed column). At least one embodiment includes preprocessing at least a portion of the dataset to handle any null or missing values in the columns. For example, null or missing values in numerical columns can be replaced by the median value of that column. After doing initial data analysis by creating one or more univariate and/or bivariate plots of the columns, the importance and/or influence of each column can be understood and/or processed. Columns that have no role or influence on the actual prediction (i.e., target variable) can be dropped and/or removed.

It is to be appreciated that this particular example pseudocode shows just one example implementation of data preprocessing, and alternative implementations can be used in other embodiments.

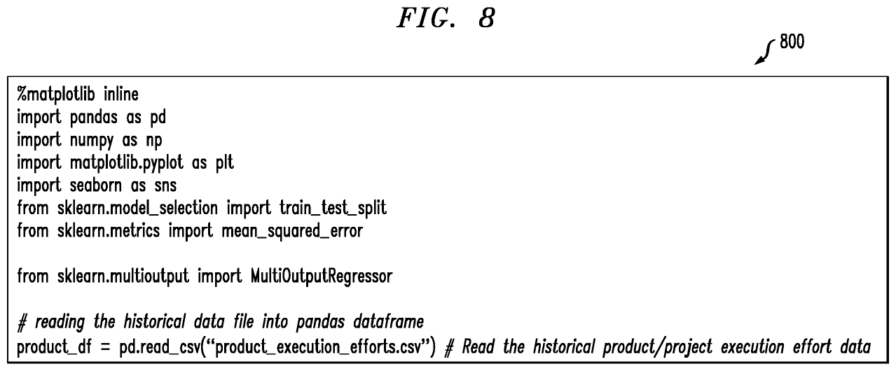

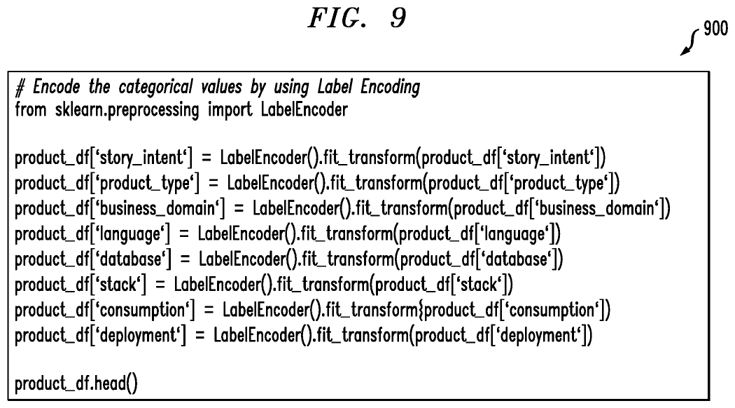

FIG. 9 shows example pseudocode for encoding categorical values into numerical values in an illustrative embodiment. In this embodiment, example pseudocode 900 is executed by or under the control of at least one processing system and/or device. For example, the example pseudocode 900 may be viewed as comprising a portion of a software implementation of at least part of task execution effort prediction system 105 of the FIG. 1 embodiment.

The example pseudocode 900 illustrates encoding textual categorical values, in the above-noted columns, to numerical values using LabelEncoder from a ScikitLearn library. For example, categorical values can include story intent name, story type, enterprise domain, etc.

It is to be appreciated that this particular example pseudocode shows just one example implementation of encoding categorical values into numerical values, and alternative implementations can be used in other embodiments.

FIG. 10 shows example pseudocode for splitting a dataset into training and testing sets in an illustrative embodiment. In this embodiment, example pseudocode 1000 is executed by or under the control of at least one processing system and/or device. For example, the example pseudocode 1000 may be viewed as comprising a portion of a software implementation of at least part of task execution effort prediction system 105 of the FIG. 1 embodiment.

The example pseudocode 1000 illustrates splitting the dataset into training and testing datasets using a train_test_split function of a ScikitLearn library (e.g., such splitting the dataset into a 70%-30% split with respect to training data and testing data). In at least one embodiment, implementation in a multi-target prediction use case can include separating both target variables (i.e., resource(s) needed and time needed) from the dataset.

It is to be appreciated that this particular example pseudocode shows just one example implementation of splitting a dataset into training and testing sets, and alternative implementations can be used in other embodiments.

FIG. 11 shows example pseudocode for neural network model creation in an illustrative embodiment. In this embodiment, example pseudocode 1100 is executed by or under the control of at least one processing system and/or device. For example, the example pseudocode 1100 may be viewed as comprising a portion of a software implementation of at least part of task execution effort prediction system 105 of the FIG. 1 embodiment.

The example pseudocode 1100 illustrates creating a multi-layer, multi-output capable dense neural network using a Keras functional model, as separate branches can be created and added to the functional model. In at least one embodiment, two separate dense layers can be added to the input layer, with each network capable of predicting different targets (e.g., resource needed and time needed).

It is to be appreciated that this particular example pseudocode shows just one example implementation of neural network model creation, and alternative implementations can be used in other embodiments.

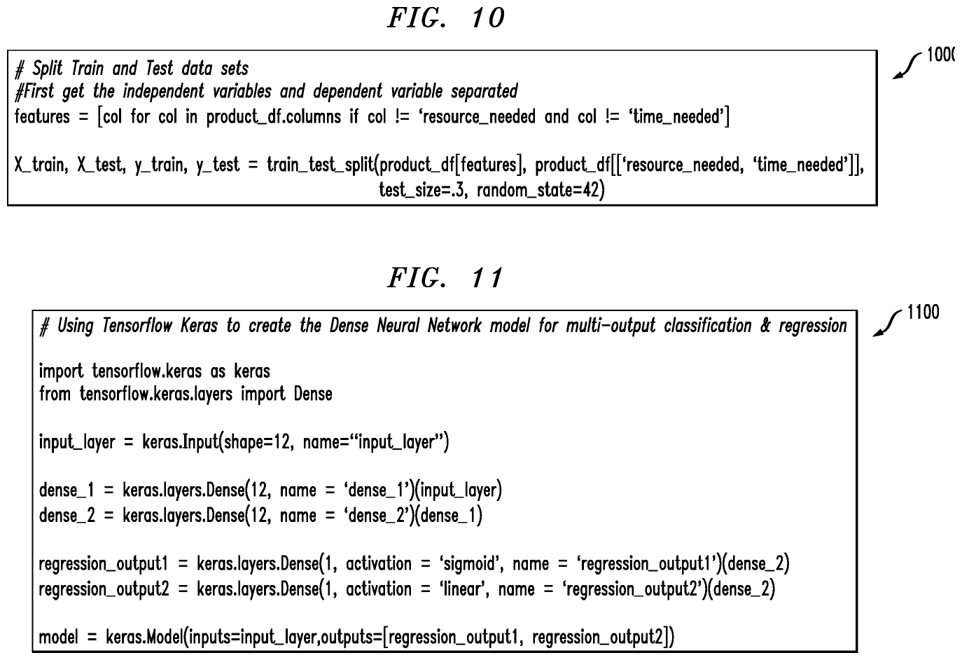

FIG. 12 shows example pseudocode for model compiling and model training in an illustrative embodiment. In this embodiment, example pseudocode 1200 is executed by or under the control of at least one processing system and/or device. For example, the example pseudocode 1200 may be viewed as comprising a portion of a software implementation of at least part of task execution effort prediction system 105 of the FIG. 1 embodiment.

The example pseudocode 1200 illustrates the model using the Adam algorithm as the optimizer and using mean squared error as the loss function for both regression branches. As also illustrated in example pseudocode 1200, the model is trained using independent variables data (X_train) and the target variables are passed for each path (both regression branches).

It is to be appreciated that this particular example pseudocode shows just one example implementation of model compiling and model training, and alternative implementations can be used in other embodiments.

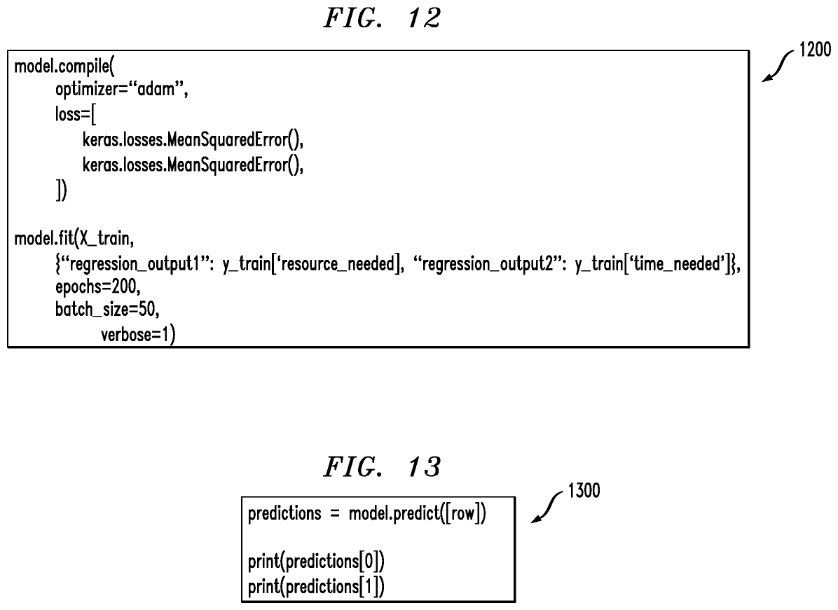

FIG. 13 shows example pseudocode for generating a prediction using the trained model in an illustrative embodiment. In this embodiment, example pseudocode 1300 is executed by or under the control of at least one processing system and/or device. For example, the example pseudocode 1300 may be viewed as comprising a portion of a software implementation of at least part of task execution effort prediction system 105 of the FIG. 1 embodiment.

The example pseudocode 1300 illustrates that once the model is trained, the model is asked to predict both target values by passing independent variable values to the predict ( ) function of the model.

It is to be appreciated that this particular example pseudocode shows just one example implementation of generating a prediction using the trained model, and alternative implementations can be used in other embodiments.

It is to be appreciated that some embodiments described herein utilize one or more artificial intelligence models. It is to be appreciated that the term “model,” as used herein, is intended to be broadly construed and may comprise, for example, a set of executable instructions for generating computer-implemented predictions. For example, one or more of the models described herein may be trained to generate predictions based on task-related intent data and/or historical task execution data collected from various systems and/or hardware components, and such predictions can be used to initiate one or more automated actions (e.g., modifying task-related decision-making with respect to technology, scope, deployment platform(s), enterprise objectives, etc., as well as automatically training and/or tuning at least a portion of the one or more models).

FIG. 14 is a flow diagram of a process for predicting task execution efforts using artificial intelligence techniques in an illustrative embodiment. It is to be understood that this particular process is only an example, and additional or alternative processes can be carried out in other embodiments.

In this embodiment, the process includes steps 1400 through 1406. These steps are assumed to be performed by task execution effort prediction system 105 utilizing elements 112, 114, 116 and 118.

Step 1400 includes determining intent information associated with at least a portion of a task by processing data related to the task using at least a first set of artificial intelligence techniques. In at least one embodiment, determining intent information associated with the at least a portion of the task includes classifying intent information associated with the at least a portion of the task by processing data related to the task using one or more neural networks. In such an embodiment, processing data related to the task using one or more neural networks can include processing at least a portion of the data related to the task using at least one bi-directional recurrent neural network. Further, in at least one embodiment, processing at least a portion of the data related to the task using at least one bi-directional recurrent neural network includes using at least one bi-directional recurrent neural network with at least one LSTM network, in conjunction with one or more natural language understanding techniques.

Determining intent information associated with the at least a portion of the task can also include processing data related to the task using one or more natural language processing techniques. Additionally or alternatively, determining intent information associated with the at least a portion of the task can include processing, using the at least a first set of artificial intelligence techniques, data pertaining to one or more of at least one enterprise domain related to the task, task type, one or more technological parameters related to the task, one or more task-related application programming interfaces, and one or more task-related hosting platforms.

Step 1402 includes determining task execution workflow data based at least in part on the intent information associated with at least a portion of the task. Step 1404 includes predicting one or more efforts associated with executing the task by processing at least a portion of the task execution workflow data using at least a second set of artificial intelligence techniques. In one or more embodiments, processing at least a portion of the task execution workflow data using at least a second set of artificial intelligence techniques includes processing the at least a portion of the task execution workflow data using at least one deep neural network having multiple parallel branches each acting as a regressor. Also, in at least one embodiment, predicting one or more efforts associated with executing the task includes predicting a number of resources needed to execute the task and/or predicting an amount of time needed to execute the task.

Additionally or alternatively, predicting one or more efforts associated with executing the task can include processing, using the at least a second set of artificial intelligence techniques and in conjunction with the at least a portion of the task execution workflow data, feature data associated with the task comprises one or more of temporal information, the intent information associated with at least a portion of the task, task type, enterprise domain associated with the task, technologies used in connection with the task, and deployment information related to the task.

Step 1406 includes performing one or more automated actions based at least in part on at least one of the one or more predicted efforts associated with executing the task. In at least one embodiment, performing one or more automated actions includes automatically training at least a portion of the at least a first set of artificial intelligence techniques using feedback related to the at least one of the one or more predicted efforts and/or automatically training at least a portion of the at least a second set of artificial intelligence techniques using feedback related to the at least one of the one or more predicted efforts. Additionally or alternatively, performing one or more automated actions can include automatically modifying one or more task execution parameters with respect to at least one of technology, scope, deployment platform, and enterprise objective.

Accordingly, the particular processing operations and other functionality described in conjunction with the flow diagram of FIG. 14 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to predict task execution efforts using artificial intelligence techniques. These and other embodiments can effectively overcome problems associated with resource-intensive and error-prone effort estimation techniques.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

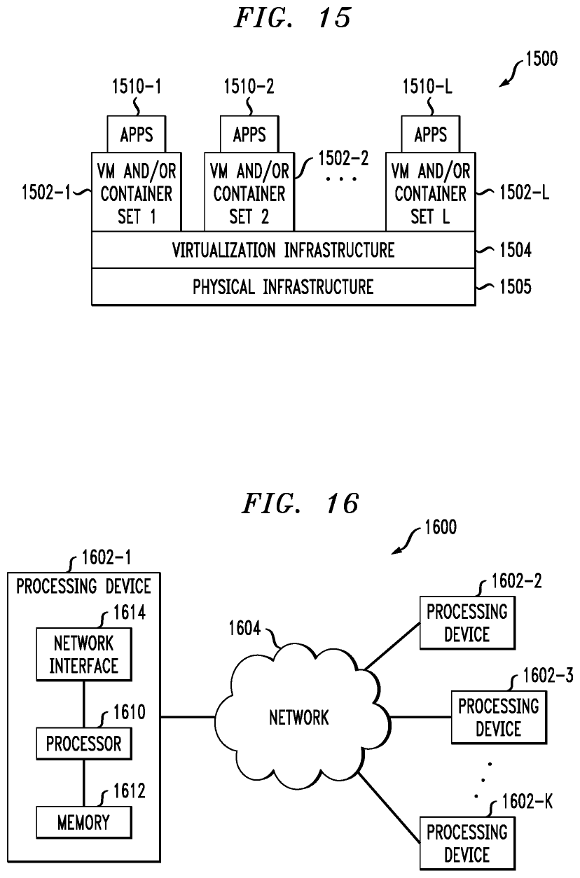

Illustrative embodiments of processing platforms will now be described in greater detail with reference to FIGS. 15 and 16. Although described in the context of system 100, these platforms may also be used to implement at least portions of other information processing systems in other embodiments.

FIG. 15 shows an example processing platform comprising cloud infrastructure 1500. The cloud infrastructure 1500 comprises a combination of physical and virtual processing resources that are utilized to implement at least a portion of the information processing system 100. The cloud infrastructure 1500 comprises multiple virtual machines (VMs) and/or container sets 1502-1, 1502-2, . . . 1502-L implemented using virtualization infrastructure 1504. The virtualization infrastructure 1504 runs on physical infrastructure 1505, and illustratively comprises one or more hypervisors and/or operating system level virtualization infrastructure. The operating system level virtualization infrastructure illustratively comprises kernel control groups of a Linux operating system or other type of operating system.

The cloud infrastructure 1500 further comprises sets of applications 1510-1, 1510-2, . . . 1510-L running on respective ones of the VMs/container sets 1502-1, 1502-2, . . . 1502-L under the control of the virtualization infrastructure 1504. The VMs/container sets 1502 comprise respective VMs, respective sets of one or more containers, or respective sets of one or more containers running in VMs. In some implementations of the FIG. 15 embodiment, the VMs/container sets 1502 comprise respective VMs implemented using virtualization infrastructure 1504 that comprises at least one hypervisor.

A hypervisor platform may be used to implement a hypervisor within the virtualization infrastructure 1504, wherein the hypervisor platform has an associated virtual infrastructure management system. The underlying physical machines comprise one or more information processing platforms that include one or more storage systems.

In other implementations of the FIG. 15 embodiment, the VMs/container sets 1502 comprise respective containers implemented using virtualization infrastructure 1504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 1500 shown in FIG. 15 may represent at least a portion of one processing platform. Another example of such a processing platform is processing platform 1600 shown in FIG. 16.

The processing platform 1600 in this embodiment comprises a portion of system 100 and includes a plurality of processing devices, denoted 1602-1, 1602-2, 1602-3, . . . 1602-K, which communicate with one another over a network 1604.

The network 1604 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1602-1 in the processing platform 1600 comprises a processor 1610 coupled to a memory 1612.

The processor 1610 comprises a microprocessor, a CPU, a GPU, a TPU, a microcontroller, an ASIC, a FPGA or other type of processing circuitry, as well as portions or combinations of such circuitry elements.

The memory 1612 comprises random access memory (RAM), read-only memory (ROM) or other types of memory, in any combination. The memory 1612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1602-1 is network interface circuitry 1614, which is used to interface the processing device with the network 1604 and other system components, and may comprise conventional transceivers.

The other processing devices 1602 of the processing platform 1600 are assumed to be configured in a manner similar to that shown for processing device 1602-1 in the figure.

Again, the particular processing platform 1600 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
determining intent information associated with at least a portion of a task by processing data related to the task using at least a first set of artificial intelligence techniques;
determining task execution workflow data based at least in part on the intent information associated with at least a portion of the task;
predicting one or more efforts associated with executing the task by processing at least a portion of the task execution workflow data using at least a second set of artificial intelligence techniques; and
performing one or more automated actions based at least in part on at least one of the one or more predicted efforts associated with executing the task;
wherein the method is performed by at least one processing device comprising a processor coupled to a memory.

2. The computer-implemented method of claim 1, wherein determining intent information associated with the at least a portion of the task comprises classifying intent information associated with the at least a portion of the task by processing data related to the task using one or more neural networks.

3. The computer-implemented method of claim 2, wherein processing data related to the task using one or more neural networks comprises processing at least a portion of the data related to the task using at least one bi-directional recurrent neural network.

4. The computer-implemented method of claim 3, wherein processing at least a portion of the data related to the task using at least one bi-directional recurrent neural network comprises using at least one bi-directional recurrent neural network with at least one long short-term memory (LSTM) network, in conjunction with one or more natural language understanding techniques.

5. The computer-implemented method of claim 1, wherein processing at least a portion of the task execution workflow data using at least a second set of artificial intelligence techniques comprises processing the at least a portion of the task execution workflow data using at least one deep neural network having multiple parallel branches each acting as a regressor.

6. The computer-implemented method of claim 1, wherein predicting one or more efforts associated with executing the task comprises predicting a number of resources needed to execute the task.

7. The computer-implemented method of claim 1, wherein predicting one or more efforts associated with executing the task comprises predicting an amount of time needed to execute the task.

8. The computer-implemented method of claim 1, wherein performing one or more automated actions comprises automatically training at least a portion of the at least a first set of artificial intelligence techniques using feedback related to the at least one of the one or more predicted efforts.

9. The computer-implemented method of claim 1, wherein performing one or more automated actions comprises automatically training at least a portion of the at least a second set of artificial intelligence techniques using feedback related to the at least one of the one or more predicted efforts.

10. The computer-implemented method of claim 1, wherein performing one or more automated actions comprises automatically modifying one or more task execution parameters with respect to at least one of technology, scope, deployment platform, and enterprise objective.

11. The computer-implemented method of claim 1, wherein determining intent information associated with the at least a portion of the task comprises processing data related to the task using one or more natural language processing techniques.

12. The computer-implemented method of claim 1, wherein determining intent information associated with the at least a portion of the task comprises processing, using the at least a first set of artificial intelligence techniques, data pertaining to one or more of at least one enterprise domain related to the task, task type, one or more technological parameters related to the task, one or more task-related application programming interfaces, and one or more task-related hosting platforms.

13. The computer-implemented method of claim 1, wherein predicting one or more efforts associated with executing the task comprises processing, using the at least a second set of artificial intelligence techniques and in conjunction with the at least a portion of the task execution workflow data, feature data associated with the task comprises one or more of temporal information, the intent information associated with at least a portion of the task, task type, enterprise domain associated with the task, technologies used in connection with the task, and deployment information related to the task.

14. A non-transitory processor-readable storage medium having stored therein program code of one or more software programs, wherein the program code when executed by at least one processing device causes the at least one processing device:
to determine intent information associated with at least a portion of a task by processing data related to the task using at least a first set of artificial intelligence techniques;
to determine task execution workflow data based at least in part on the intent information associated with at least a portion of the task;
to predict one or more efforts associated with executing the task by processing at least a portion of the task execution workflow data using at least a second set of artificial intelligence techniques; and
to perform one or more automated actions based at least in part on at least one of the one or more predicted efforts associated with executing the task.

15. The non-transitory processor-readable storage medium of claim 14, wherein determining intent information associated with the at least a portion of the task comprises classifying intent information associated with the at least a portion of the task by processing data related to the task using one or more neural networks.

16. The non-transitory processor-readable storage medium of claim 15, wherein processing data related to the task using one or more neural networks comprises processing at least a portion of the data related to the task using at least one bi-directional recurrent neural network.

17. The non-transitory processor-readable storage medium of claim 14, wherein processing at least a portion of the task execution workflow data using at least a second set of artificial intelligence techniques comprises processing the at least a portion of the task execution workflow data using at least one deep neural network having multiple parallel branches each acting as a regressor.

18. An apparatus comprising:
at least one processing device comprising a processor coupled to a memory;
the at least one processing device being configured:
to determine intent information associated with at least a portion of a task by processing data related to the task using at least a first set of artificial intelligence techniques;
to determine task execution workflow data based at least in part on the intent information associated with at least a portion of the task;
to predict one or more efforts associated with executing the task by processing at least a portion of the task execution workflow data using at least a second set of artificial intelligence techniques; and
to perform one or more automated actions based at least in part on at least one of the one or more predicted efforts associated with executing the task.

19. The apparatus of claim 18, wherein determining intent information associated with the at least a portion of the task comprises classifying intent information associated with the at least a portion of the task by processing data related to the task using one or more neural networks.

20. The apparatus of claim 18, wherein processing at least a portion of the task execution workflow data using at least a second set of artificial intelligence techniques comprises processing the at least a portion of the task execution workflow data using at least one deep neural network having multiple parallel branches each acting as a regressor.
